(19) United States
(12) Patent Application Publication
(10) Pub. No.: US 2010/0077489 A1
(43) Pub. Date: Mar. 25, 2010

(54) METHOD, APPARATUS, AND COMPUTER PROGRAM PRODUCT FOR ISOLATING PERSONAL DATA

(76) Inventor: Joel H. AKE, boulogne (FR)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/564,401

(22) Filed: Sep. 22, 2009

Related U.S. Application Data
(60) Provisional application No. 61/099,563, filed on Sep. 23, 2008.

(51) Int. Cl. H04L 9/32

(52) U.S. Cl. 726/30

(57) ABSTRACT

A method, user equipment, network device, and software product that protects data confidentiality where data transmission is required between distant systems. The invention comprises splitting data into confidential and non-confidential data. The invention further includes an isolating indexation responsible for data transmission, processing and reconciliation. Also, the invention comprises data confidentiality protection where multiple systems are involves.

### CROSS REFERENCE TO RELATED TO RELATED APPLICATION

This application claims benefit to provisional patent application Ser. No. 61/099,563, filed 23 Sep. 2008, which is hereby incorporated by reference in its entirety.

### FIELD OF THE INVENTION

The present invention relates to the field of data confidentiality, and more particularly to data confidentiality during communication via the Internet or via information technology (IT) systems connected through computer networks.

### BACKGROUND OF THE INVENTION

In recent years, data confidentiality and security on the Internet have become an important issue. Large mainstream companies are using the Internet, and most individuals use it as well. Many applications require personal data (also called “nominative data” herein), for example to contact a specific user, or to store that data for a specific business reason. Some large corporations outsource the personal data for specific business purposes, with the permanent fear of having strategic data stolen, lost, or hacked.

Users are often solicited to enter their private data, either to complete an e-commerce transaction, use a social network, or merely to register for an information alert service. Among all the nominative data disclosed, some of it is subsequently used maliciously, either consciously or unconsciously. Users are concerned about the use of this personal data, and after having been disappointed by abusive usages such as spam, inadequate advertising, or harassment, many users try to avoid disclosing their personal data as often as possible.

It is known to prevent hackers and spammers from accessing a computer or local network by surrounding it with a firewall. However, because not everything is protected by firewall, and because some firewalls are imperfect, hackers and spammers still try to obtain personal data in order to use in their campaigns. Likewise, legitimate advertisers and marketers being in possession of their customers' or prospects' nominative data may indulge in sending inappropriate or too-frequent online or email solicitations.

It is also known to employ a reverse firewall. While a traditional firewall is designed to stop attacks or spam from the outside coming in, a reverse firewall stops an attack or spam going out. This precaution reduces the chance that a person's computer can be hijacked to distribute huge amounts of fraudulent e-mail or launch denial-of-service attacks without being traced directly. Normal users have no need to send out floods of e-mail, which reverse firewalls can stop, but they do allow a normal flow of e-mail. Unfortunately, even a reverse firewall is unable to prevent disclosure of nominative data to the outside world, during normal communications by a normal user, and even if such disclosure were achieved it would render the user unable to participate in activities that have heretofore required nominative data to be disclosed.

Because both well-intentioned and unscrupulous corporations have access to sophisticated technologies for bulk or spam mail communication, users tend to be very reluctant to give data when requested, and this only refers to reluctance about mail, without even referring to the many other undesirable uses of personal data that can reluctant users to refuse cooperation. This fast-paced and very negative trend has been rocking the foundation of trust in e-commerce and internet communications.

With this ever-increasing problem, both individual users and well-intentioned corporations are in a lose-lose situation wherein users cannot access useful services requiring data disclosure, and corporations cannot provide them. Major European countries regularly increase their legal regulations and constraints for any database storage and data transmission when nominative information are involved. Soon, most industrialized countries will enact stricter and stricter laws regarding nominative data protection. Therefore, and efficient way to protect this data is needed.

Today, a corporation that wants part of its process outsourced risks breaching data confidentiality. This prevents the outsourcing market from expanding, where real added value could be brought and efficiency increased by outsourcing specific tasks to experts or low-cost service providers. In the meantime, users are trying to avoid data disclosure, which increases the trigger level at which the user perceives such a high added value in a product or a service to take the risk of disclosure. An individual user may refrain from using even free internet services, such as social networking web sites, for fear that their personal data will fall into the wrong hands. In this example, users may be more concerned about data confidentiality when using a social network, because not only their personal data may be used in an inappropriate manner, but also the personal data regarding their friends that their friends may have provided to them.

In view of the forgoing, what is needed is a method, apparatus, system and software for allowing corporate data processes to use confidential or nominative data without risk of disclosing them, or to allow individual users to similarly protect their confidential data while still taking full advantage of available communication opportunities.

### SUMMARY OF THE INVENTION

Although the present invention is applicable in the context of the internet, its principles are not limited to the internet, and instead may also be applicable to various other current and future communications systems, such as, but not limited to mobile phone, blackberry, Iphone, or corporate extranet networks communications.

The present invention addresses the problems described above by providing an embodiment of the invention wherein a computer-implemented method allows exchanges of information within a corporation, or within a set of corporations, or between a corporation and an individual user, where confidential data need not to be disclosed. Confidential data may refer to different kinds of data, depending upon the business sector involved.

The most common meaning of confidential data is nominative (i.e. personal) data as far as individuals are concerned. This generally means data that a user might not want to become publicly available. For example, nominative data may include the user's name, or email address, or physical address, or other information that typically identifies or describes the individual.

The method according to an embodiment of the present invention includes synchronizing data between two distant databases, where a tiers-object (e.g. a key) is in charge of reconciliation, and every confidential data stays in their origin database. Generally, the tiers-object is encrypted, but not necessarily. This method further includes determining a data exchange process and sequencing that allows both distant systems to perform their duties on the correct object with the correct data.

In another embodiment, an interface protocol is provided for more sophisticated processes. Punctual access to confidential data is allowed by one system to another system, without having to store that confidential data on the other side.

In a further embodiment, the method comprises synchronizing data between one database and an individual computer or connected device. The individual is represented by a tiers-object which is in charge of reconciliation, and all confidential data stays on the individual's computer or connected device. Generally, the tiers-object is encrypted, but not necessarily. This method further includes determining a data exchange process and sequencing that allows a distant system to perform its duties on the correct individual with the correct data.

In yet another embodiment, the method comprises synchronizing data between one database and individuals' computers or connected devices. According to that embodiment, individuals are represented by tiers-objects that are in charge of reconciliation, and all confidential data stays on the individuals' computers or connected devices. That embodiment allows organizations, for example, to manage their members without confidentiality breaches. Generally, the tiers-object is encrypted, but not necessarily. The method further includes determining a data exchange process and sequencing to allow a distant system to perform its duties on the correct individuals with the correct data.

In yet another embodiment, the method comprises synchronizing data between one database and the distant servers or connected devices of a corporation or organization. According to that embodiment, lists of individuals including individuals' data are represented by tiers-objects that are in charge of reconciliation, and all confidential data stays on the servers or connected devices of the corporation or organization. That embodiment allows corporations and organizations, for example, to manage their database of individuals without confidentiality breaches. Individuals can be customers, members, users, employees or any other group of individuals connected to the corporation or the organization. Generally, the tiers-object is encrypted, but not necessarily. The method further includes determining a data exchange process and sequencing to allow a distant system to perform its duties on the correct individuals with the correct data.

Advantageously, the present invention allows corporations, organizations, and users to utilize distant applications, or to share distant applications, or to outsource data processes, without risk of confidentiality breaches. The present invention allows corporations to broaden their opportunities and applications for beneficial investment by unleashing business opportunities without fear of data protection breaches, thus allowing corporations and organizations to outsource globally with reduced risk, and allowing individuals to access numerous distant applications.

### BRIEF DESCRIPTION OF THE DRAWINGS

The invention, together with further advantages thereof, may best be understood by reference to the following description taken in conjunction with the accompanying drawings in which:

FIG. 1 is a flow chart showing a method according to an embodiment of the invention;

FIG. 2 is block diagram showing an apparatus according to an embodiment of the invention.

### DETAILED DESCRIPTION OF THE INVENTION

Preferred embodiments of the present invention will now be described. This is merely to illustrate ways of implementing the invention, without limiting the scope or coverage of what is described elsewhere in this application. An invention is described for preserving data confidentiality involving internet applications or IT systems connected through computer networks.

In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

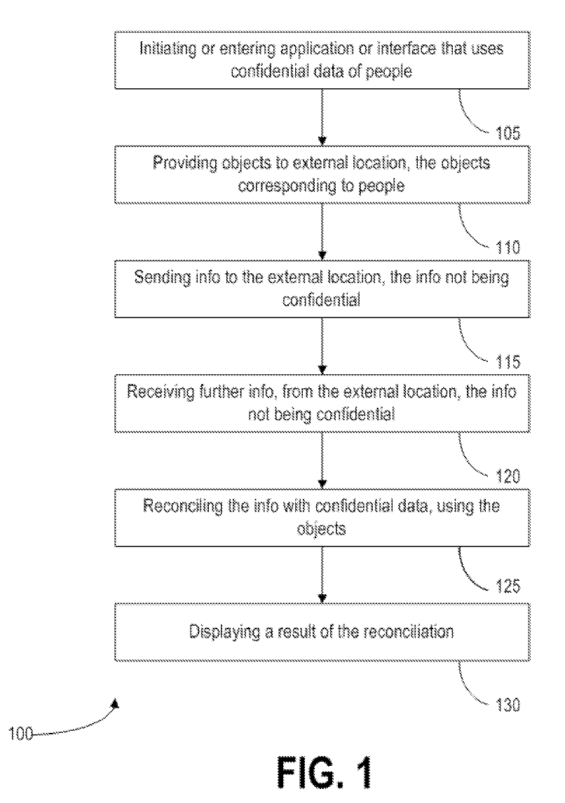

An embodiment of the present invention includes a method 100 shown in FIG. 1, and software having steps for performing that method. The method includes a step 105 for initiating or entering an application or interface that uses data including confidential data which is associated with a plurality of entities. In a step 110, a first signal is provided containing information about at least one object via a network to an external location, said at least one object corresponding to at least one of said entities. In a step 115, a second signal is provided containing information via said network to said external location. In a step 120, a third signal is received containing further information via said network from said external location. The further information is at least partly in response to said providing the at least one object. Substantially all data communicated to and from said external location via said network, including said at least one object, said information, and said further information, is distinct from said confidential data. In a step 125, said further information is reconciled with said confidential data, using said at least one object, and a fourth signal is provided containing information about a result of the reconciliation. A step 130 includes displaying the result of said reconciliation.

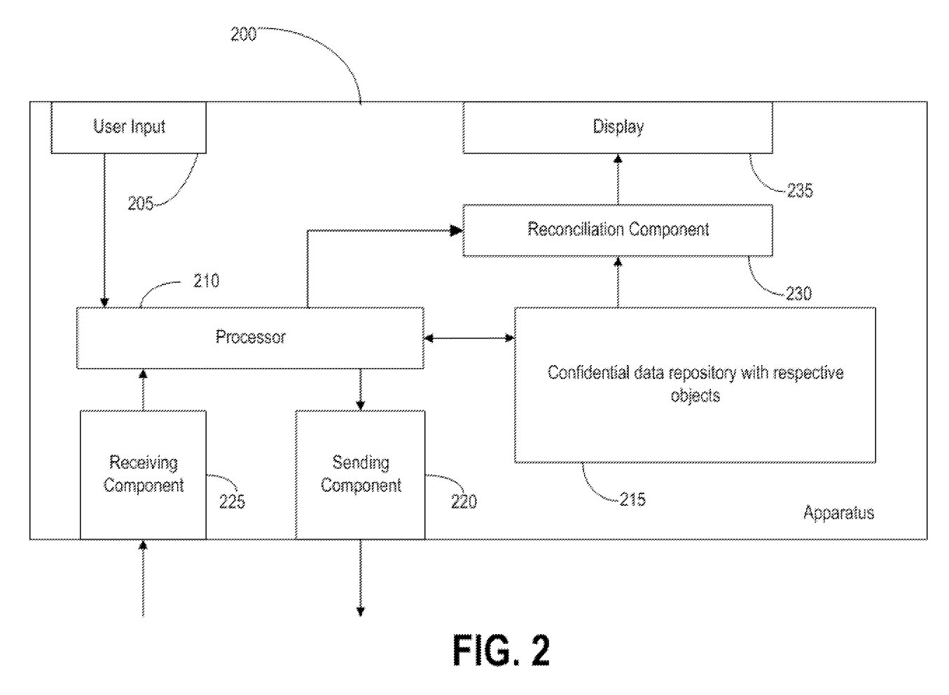

An embodiment of the present invention includes an apparatus 200 shown in FIG. 2, for performing the method just described, including a user input 205, a processor 210, a confidential data repository 215, a sending component 220, a receiving component 225, a reconciliation component 230 and a display 235. The user input component 205 is configured to provide the first signal containing information to initiate or enter an application or interface that uses data including confidential data which is associated with a plurality of entities. The object repository 215 is configured to provide the second signal containing information about at least one object via a network to an external location, said at least one object corresponding to at least one of said entities. The object repository 215 may also be where confidential data is stored. The sending component 220 is configured to provide the third signal to send information via said network to said external location, and the receiving component 225 is configured to receive the third signal containing further information via said network from said external location. This further information is at least partly in response to the at least one object previously provided. Substantially all data communicated to and from said external location via said network, including said at least one object, said information, and said further information, is distinct from said confidential data. The reconciliation component 230 is configured to reconcile said further information with said confidential data, using said at least one object, and to provide a signal containing information about a result of the reconciliation and provide a fourth signal containing information about the reconciliation. The display 235 is configured to display the result of said reconciliation received from the reconciliation component 230. The processor 210 is configured to process signaling between the various components consistent with that shown and described herein.

In accordance with one aspect of the present invention, the aforementioned data confidentiality problem is addressed by providing each party with a data connector-protector. The present invention may be practiced in the context of a personal computer such as an IBM compatible personal computer, Apple Macintosh computer or UNIX based workstation, mobile phones, smart phones, blackberry devices, or any other connected device.

A workstation includes a central processing unit, such as a microprocessor, and a number of other units interconnected via a system bus. The workstation further includes Random Access Memory (RAM), Read Only Memory (ROM), and an I/O adapter for connecting peripheral devices such as disk storage units, to the bus. Also included is a user interface adapter for connecting a keyboard, mouse, speakers, and/or microphone to the system bus. Finally, the workstation includes a display adapter for connecting a display device to the system bus, and a communications adapter for connecting the workstation to a communication network, such as the Internet.

The workstation typically has resident thereon an operating system such as the Microsoft Windows, IBM OS/2, MAC OS, LINUX, or UNIX. Those skilled in the art will appreciate that the present invention may also be implemented on other suitable platforms and operating systems.

An isolation of confidential data between a user's PC or connected device and a distant database or website may be accomplished in accordance with one embodiment of the present invention. A distant database includes data divided into a working data section (usually non confidential ones) and a confidential data section. The distant database is physically contained on a physical storage hardware that can be a hard disk, or any type of storage memory. This physical storage hardware is part of a computer system connected via a network to the external world.

This external world connects to a user's PC or connected device. This user PC or connected device a storage hardware that includes a set data, that could be gathered into a database or gathered in a single piece of data if their structure, complexity and size do not demand a specific database to contain and manage the above mentioned user data.

The set of data or user's database is divided onto two parts: working data and confidential data, and an isolation component.

The following detailed process illustrates how an isolation component is build, for the case of a regular relational database where each record is represented as a row and each attribute as a column. Each record or row of data has parts of its attributes in the working data section, parts of its attributes in the confidential section. An isolation component is created that includes at least two attributes, the internal isolation index and the external isolation index. The internal isolation index is an index created by the system points to the correct record or row in the user's set of data or database. The external isolation index created by the system points to the correct record or row in the external database.

Referring next to the distant database, each record or row of data has parts of its attributes in the working data section, parts of its attributes in the confidential section. An isolation component is created that includes at least two attributes, the internal isolation index and the external isolation index. The internal isolation index is an index created by the system points to the correct record or row in the distant database. The external isolation index created by the system points to the correct record or row in the external user's set of data or database.

Together, the two isolation components allow a distant IT system or website to process data regarding a user without uploading confidential data, processing working data only, while the isolation components are in charge of reconciling the correct information for the user on one side, for the distant database on the other side.

According to an embodiment of this invention, an individual can use a distant social network website for managing his or her social network containing nominative data without disclosing these confidential data to the distant application or website. His or her nominative data and the ones of his or her friends and relations are stored locally on his PC or connected device. Each record is being assigned an internal isolation index and an external isolation index via the isolation component. All needed information for processing social network management tasks are transmitted to the external application, together with the external index. The external application receives the data and creates its own internal and external index, where its internal index depends on its local data constraints and its external index refers in a unique manner to the external index provided by the user.

The isolation component residing on the distant database is in charge of the data reconciliation.

After necessary tasks have been processed, results are transmitted back to the user, using the reverse process for reconciliation between corresponding internal and external indexes.

An embodiment of the present invention can perform isolation of confidential data between a user's PC or connected device and a distant database or website in accordance with one embodiment of the present invention. The first distant database includes data divided into a working data section (usually non-confidential ones) and a confidential data section. The distant database is physically contained on a physical storage hardware that can be a hard disk, or any type of storage memory. This physical storage hardware is part of a computer system connected via a network to the external world.

This external world connects to a distant second database. This second distant database includes data divided into a working data section (usually non-confidential ones) and a confidential data section. This second distant database is physically contained on a physical storage hardware that can be a hard disk, or any type of storage memory. This physical storage hardware is part of a computer system connected via a network to the external world.

The second database is divided onto two parts: working data and confidential data, and an isolation component.

The following detailed process illustrates how an isolation component is build, for the case of a regular relational database where each record is represented as a row and each attribute as a column. Each record or row of data has parts of its attributes in the working data section, parts of its attributes in the confidential section. An isolation component is created that includes at least two attributes, the internal isolation index and the external isolation index. The internal isolation index is an index created by the system points to the correct record or row in the second database. The external isolation index created by the system points to the correct record or row in the external first database.

Referring next to the distant first database, each record or row of data has parts of its attributes in the working data section, parts of its attributes in the confidential section. An isolation component is created that includes at least two attributes, the internal isolation index and the external isolation index. The internal isolation index is an index created by the system points to the correct record or row in the distant database. The external isolation index created by the system points to the correct record or row in the external second database.

Together, the two isolation components allow a distant IT system or website to process data regarding a user without uploading confidential data, processing working data only, while the isolation components are in charge of reconciling the correct information for the second database on one side, for the first distant database on the other side, and vice-versa.

According to an embodiment of the present invention, a second corporation is using a distant application for managing its individual's relations containing nominative and confidential data without disclosing these confidential data to the distant application or website. Individuals can be customers, members, users, employees or any other group of individuals connected to the corporation or the organization. Such distant application can be, but not limited to: a CRM application. Nominative and confidential data are stored locally on the second database. Each record is being assigned an internal isolation index and an external isolation index via the isolation component. All needed information for processing the distant application management tasks are transmitted to the external application, together with the external index. The external application receives the data and creates its own internal and external index, where its internal index depends on its local data constraints and its external index refers in an unique manner to the external index provided by the second database.

The isolation component residing on the distant database is in charge of the data reconciliation.

After necessary tasks have been processed, results are transmitted back to the corporation or organization, using the reverse process for reconciliation between corresponding internal and external indexes.

According to an embodiment of the present invention, a distant system or website processes confidential data on another system or website without storing the real data, and processing delude data.

This embodiment treats the case where the application working with second the distant database needs to access to confidential data contained into the first database.

The following detailed process illustrates how the isolation component will work, additionally to its basic function already described, to act as a delude system for the second database, therefore protecting confidentiality of its strategic data. The isolation component splits the working data into non-strategic working data, and strategic working data. It creates a double level of isolation indexation. While the previous internal isolation index and external isolation index previously described becomes first level isolation index and first level external isolation index, another second level internal isolation index is created. First level isolation index and first level external index will be used for data reconciliation. Second level internal index will be used to scramble nominative data randomly and provide the correct strategic and non-strategic data to the second database for processing with fake confidential data. This means that the first level of isolation is between the database and the corporation servers, and the second level of isolation is between the corporation servers and the individuals' computers.

A simplified process uses only one level of isolation between the database and the corporation servers. That will work like the first embodiment between the user and the database, unless in that case, the corporation data (i.e. list of its customers) are protected from the distant database. In that case of only one level of isolation, the protection is only for the corporation, not for the user (but marketers may use outsourced application using the data of their customers). With the double level of isolation, the user is protected, as neither the distant database nor the corporation has his confidential data.

While the present invention has been described in terms of several preferred embodiments, there are many alterations, permutations, and equivalents which may fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

Encryption can be used in the isolation components, using for example public keys on second database and private keys on user's set of data or first database.

Confidential data includes non only nominative data but can be of any other species such as financial ones, bank account numbers, bank account balances, or passwords, logins, user'IDs, Software licenses' keys and the like. Database can be outsourced, enriched externally, and reconciled back to the origin database.

Embodiments described above can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a CPU processor, comprising a single processing unit, multiple processing units capable of parallel operation, or the CPU can be distributed across one or more processing units in one or more locations, e.g., on a client and server. A memory may comprise any known type of data storage and/or transmission media, including magnetic media, optical media, random access memory (RAM), read-only memory (ROM), a data cache, a data object, etc. Moreover, similar to the CPU, the memory may reside at a single physical location, comprising one or more types of data storage, or be distributed across a plurality of physical systems in various forms.

It is to be understood that the present figures, and the accompanying narrative discussions of best mode embodiments, do not purport to be completely rigorous treatments of the method, system, mobile device, network element, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

The following claims exemplify various ideas related to the present invention, and are not intended to limit in any way what may eventually be claimed in any subsequent application based upon that disclosed in this application.

What is claimed is:

1. A method comprising:
initiating or entering an application or interface that uses data including confidential data which is associated with a plurality of entities,
providing a first signal containing information about at least one object via a network to an external location, said at least one object corresponding to at least one of said entities,
sending a second signal containing information via said network to said external location, and
receiving a third signal containing further information via said network from said external location,
wherein said further information is at least partly in response to said providing the at least one object,
wherein substantially all data communicated to and from said external location via said network, including said at least one object, said information, and said further information, is distinct from said confidential data,
reconciling said further information with said confidential data, using said at least one object, and providing a fourth signal containing information about a result of the reconciliation, and
displaying the result of said reconciliation.

2. The method of claim 1, wherein said entities are persons, wherein said confidential data is confidential personal data, wherein said object is an encrypted key, wherein said external location is a server, and wherein said providing, sending, receiving, reconciling, and displaying are performed during use of said application or interface.

3. The method of claim 1, wherein said information is sent to said external location after isolating substantially all of said confidential data that would otherwise be included in said information.

4. The method of claim 1, wherein said further information received from said external location is also at least partly in response to said information sent to said external location.

5. The method of claim 3, wherein said reconciliation counteracts a splitting that was previously accomplished by said isolating.

6. The method of claim 1,
wherein said plurality of said entities includes a foreign entity,
wherein said at least one object includes a foreign object corresponding to said foreign entity,
wherein said confidential data includes foreign confidential data corresponding to said foreign entity, and
wherein said foreign object and said foreign confidential data have been received from said foreign entity instead of from said external location.

7. The method of claim 6, wherein said foreign object and said foreign confidential data have been received from said foreign entity via electronic mail, via a secure web site, or via a portable data storage device.

8. The method of claim 3, wherein said isolating renders said data communicated to and from said external location distinct from said confidential data.

9. The method of claim 6, wherein said foreign entity refers to any of said entities elsewhere than where said method occurs.

10. The method of claim 1, wherein said plurality of entities includes a local entity where said method occurs.

11. A computer program product comprising a computer readable medium having executable code stored therein; the code, when executed by a processor, adapted to carry out a method comprising:
initiating or entering an application or interface that uses data including confidential data which is associated with a plurality of entities,
providing a first signal containing information about at least one object via a network to an external location, said at least one object corresponding to at least one of said entities,
sending a second signal containing information via said network to said external location, and
receiving a third signal containing further information via said network from said external location,
wherein said further information is at least partly in response to said providing the at least one object, and
wherein substantially all data communicated to and from said external location via said network, including said at least one object, said information, and said further information, is distinct from said confidential data,
reconciling said further information with said confidential data, using said at least one object, and providing a fourth signal containing information about a result of the reconciliation,
displaying the result of said reconciliation.

12. The computer program product of claim 11, wherein said entities are persons, wherein said confidential data is confidential personal data, wherein said object is an encrypted key, wherein said external location is a server, and wherein said providing, sending, receiving, reconciling, and displaying are performed during use of said application or interface.

13. The computer program product of claim 11, wherein said information is sent to said external location after isolating substantially all of said confidential data that would otherwise be included in said information.

14. The computer program product of claim 11, wherein said further information received from said external location is also at least partly in response to said information sent to said external location.

15. The computer program product of claim 13, wherein said reconciliation counteracts a splitting that was previously accomplished by said isolating.

16. The computer program product of claim 11,
wherein said plurality of said entities includes a foreign entity,
wherein said at least one object includes a foreign object corresponding to said foreign entity,
wherein said confidential data includes foreign confidential data corresponding to said foreign entity, and
wherein said foreign object and said foreign confidential data have been received from said foreign entity instead of from said external location.

17. The computer program product of claim 16, wherein said foreign object and said foreign confidential data have been received from said foreign entity via electronic mail, via a secure web site, or via a portable data storage device.

18. The computer program product of claim 13, wherein said isolating renders said data communicated to and from said external location distinct from said confidential data.

19. The computer program product of claim 16, wherein said foreign entity refers to any of said entities elsewhere than where said method occurs.

20. The computer program product of claim 11, wherein said plurality of entities includes a local entity where said method occurs.

21. An apparatus comprising:
a user input component configured to provide a first signal to initiate or enter an application or interface that uses data including confidential data which is associated with a plurality of entities,
an object repository configured to provide a second signal containing information about at least one object via a network to an external location, said at least one object corresponding to at least one of said entities,
a sending component configured to provide a third signal to send information via said network to said external location, and
a receiving component configured to receive a fourth signal containing further information via said network from said external location,
wherein said further information is at least partly in response to said at least one object, and
wherein substantially all data communicated to and from said external location via said network, including said at least one object, said information, and said further information, is distinct from said confidential data,
a reconciliation component configured to reconcile said further information with said confidential data, using said at least one object, and to provide a signal containing information about a result of the reconciliation
a display configured to display the result of said reconciliation.

22. The apparatus of claim 21, wherein said entities are persons, wherein said confidential data is confidential personal data, wherein said object is an encrypted key, wherein said external location is a server, and wherein said providing, sending, receiving, reconciling, and displaying are performed during use of said application or interface.

23. The apparatus of claim 21, wherein said information is sent to said external location after isolating substantially all of said confidential data that would otherwise be included in said information.

24. The apparatus of claim 21, wherein said further information received from said external location is also at least partly in response to said information sent to said external location.

25. The apparatus of claim 23, wherein said reconciliation counteracts a splitting that was previously accomplished by said isolating.

26. The apparatus of claim 21,
wherein said plurality of said entities includes a foreign entity,
wherein said at least one object includes a foreign object corresponding to said foreign entity,
wherein said confidential data includes foreign confidential data corresponding to said foreign entity, and
wherein said foreign object and said foreign confidential data have been received from said foreign entity instead of from said external location.

27. The apparatus of claim 26, wherein said foreign object and said foreign confidential data have been received from said foreign entity via electronic mail, via a secure web site, or via a portable data storage device.

28. The apparatus of claim 23, wherein said isolating renders said data communicated to and from said external location distinct from said confidential data.

29. The apparatus of claim 26, wherein said foreign entity refers to any of said entities elsewhere than where said apparatus is located.

30. The apparatus of claim 21, wherein said plurality of entities includes a local entity where said apparatus is located.
